(19) United States
(12) Patent Application Publication
(10) Pub. No.: US 2014/0135087 A1
(43) Pub. Date: May 15, 2014

(54) Brain-teaser

(71) Applicant: Alexander Luchinskiy, Bad Kreuznach (DE)

(72) Inventor: Alexander Luchinskiy, Bad Kreuznach (DE)

(21) Appl. No.: 14/106,764

(22) Filed: Dec. 14, 2013

Related U.S. Application Data
(60) Provisional application No. 61/737,655, filed on Dec. 14, 2012.

(30) Foreign Application Priority Data
Jun. 21, 2010 (DE) 10 2010 024 528.3
Dec. 14, 2011 (DE) 10 2011 120 927.5

(51) Int. Cl. G07F 17/32

(52) U.S. Cl. CPC G07F 17/3286
USPC 463/9

(57) ABSTRACT

A real, i.e. not-virtual, brain-teaser or game with the mechanically operated elements is provided, by which a motoric practicing of hands and fingers by operations with the real mechanical elements and a learning experience by manual operations with the real objects is provided simultaneously with the functions, possibilities and variabilities, which are provided by computer games.

### CROSS-REFERENCE TO RELATED APPLICATIONS

This application claims the priority benefits to U.S. provisional patent application, Ser. No. 61/737,655 filed Dec. 14, 2012; to German Patent Application DE 10 2011 120 927.5, filed Dec. 14, 2011, published Jun. 22, 2013; to German Patent Application DE 10 2010 024 528.3, filed Jun. 21, 2010, published Dec. 22, 2011.

### STATEMENT REGARDING FEDERALLY SPONSORED RESEARCH OR DEVELOPMENT

Not Applicable

### REFERENCE TO SEQUENCE LISTING; A TABLE; OR A COMPUTER PROGRAM LISTING COMPACT DISK APPENDIX

Not Applicable

### BACKGROUND OF THE INVENTION

(1) Field of the Invention:

The present invention relates to brain-teasers and games.

(2) Description of Related Art

The brain-teasers and mechanical games are generally known, as for example Rubik's-cube, Lego-meccano, any kind of meccano (kit), puzzle, collection of bricks, etc., where one operates manually with the mechanical elements. These brain-teasers and mechanical games do not provide the functions, which are provided by PC-games. Therefore their functions, possibilities and variabilities are limited, both in the aspect of entertainment and in the educational aspect, in comparison with the computer games.

The PC-games and further electronic games are generally known, where one can operate only with the virtual elements on a display. Therewith one can practicing a motoric of hands and fingers only limitedly. Besides, the motoric experience by operations with the real and virtual objects is not the same. Motoric practicing of hands and fingers by operations with the real objects is necessary for a true development of a child's brain, spinal cord and nervous system. One cannot substitute this a.m. practicing by the similar operations with the virtual objects through keyboard, joystick, touchable display, Wii-console or other devices for interaction with virtual objects. And besides, by executing of operations with virtual objects in computer games, a child does not get an experience of operation in real space with real three-dimensional objects (as for example with any kinds of real (not virtual) meccanos).

As it is known, the child's nervous system develops itself not only by biochemical mechanisms of a memory. Clusters of nerve cells also grow dependently on the corresponding current child's practicing. With another words, a development of child by his interaction with an external world takes place not only by developing of a “software” of human brain, but also by developing of a “hardware” of a human central and peripherious nervous system. Therefore for a true development of a child, both mental and biological one, his practicing have to contain the experiences of operations with both real and virtual objects. These two experiences have to complement each other, but they cannot substitute each other.

### BRIEF SUMMARY OF THE INVENTION

Aim of the presented invention is to provide a brain-teaser or a game, where one could practicing a motoric of hands and fingers by operations with the real objects in a mechanical brain-teaser or mechanical game (as f.e. Rubik's cube, Lego-meccano, any kind of meccano (kit, Konstruktionsbaukasten), puzzle, collection of bricks, etc.), nevertheless also by simultaneous using of the spectrum of functions and possibilities usually provided by PC-games. This problem is solved in the listed in the claims features.

The attained by this inventions advantages are, in particular, that it makes it possible to involve the motoric-developing practicing of hands and fingers by complicated operation with the real objects into the PC-based games. As well that one can practically use the new possibilities and training aspects of the known old mechanical brain-teasers or games, which possibilities arisen by the interaction of the mechanical elements in these brain-teasers and games with the virtual images of these elements. In particular one can assemble the necessary combinations of elements in the Rubik's-cube, Lego or in any meccano, and by doing so to be guided by the movements of the virtual images of these elements on a PC-display, or by other kind of notes and instructions in graphical form, text form, in the form of sound signals or spoken advices or in any other form. Where the every of the a.m. current movements of virtual images, notes or instructions are depend on the current position and orientation of the a.m. mechanical elements.

These a.m. notes or instructions can arisen not only in a PC-display&sound output, but also directly in the indicators or other signalling devices, which are located on (in) the a.m. mechanical elements. In the last case a PC processes the a.m. data concerning the relative positions and orientations of the a.m. elements and transfers the commands to indicators or other signalling devices, which indicators (signalling devices) are located on (in) the a.m. elements.

In separate cases instead of the a.m. signals also the movements of the a.m. elements (or their parts) can be used, which movements could be driven by the controlled from PC electric-mechanical converters.

### DETAILED DESCRIPTION OF THE INVENTION

The examples of embodiment of the invention are described below.

The subject of one group of possible embodiment is a mechanical brain-teaser or a mechanical game, which one consists a.o. (among others) of a collection or composition of mechanical elements (in the future they are named as “working elements”), which elements are made such way, that a definite placing (or orientation) in the space of these elements relative to each other is provided (a.o. Rubik's cube, Lego-meccano, puzzle, any kind of meccano (or kit), collection of bricks (cubes), etc.).

The above-mentioned elements are made with the possibility to recognise and identify both these elements themselves and the relative positioning (or orientation or both) of these elements relative to each other by means of a PC and its periphery-devices, or by means of any other electronic device. Or also a relative position of at least two of these elements is recognisable by a PC with its periphery-devices (or by any other electronic device).

As the a.m. periphery-devices, among others, any known devices can be used, which are able to recognise the relative position (or relative orientation or both) of mechanical working elements. It can be, among others an optical camera (or several fixed in different positions optical cameras), which are able to recognise the a.m. parameters of mechanical working elements and transfer them in the form of electronic data to a PC for further processing.

The a.m. working elements can also contain inside them, or on their surfaces, the identification markings or the generators of identification-signals (in electric, magnetic, optic, acoustic or any other form) and the detectors to read these markings or signals. When two working elements are put together (or they are put together in a definite orientation, or both), the a.m. detectors send the correspondent current data to the PC. The detectors can be located also not always on the each of working elements, but also outside them dependently on the construction. The a.m. markings as well as generators of identification signals with the detectors for their recognising are generally known and belong to state of technology.

The data from the a.m. periphery-devices or from the a.m. detectors, are transferred to the PC and processed there. After that the results of these processing are transferred to the PC-display and presented there in the form of virtual images of the a.m. real working elements or (and) in the form of any current notes or instructions. To execute the current operations with the a.m. real mechanical working elements, the user is guided by the movements of the virtual images of these elements on a PC-display, or by other kind of notes and instructions in graphical form, text form, in the form of sound signals or spoken advices or in any other form. Where the every of the a.m. current movements of virtual images, notes or instructions are depend on the current position and orientation of the a.m. mechanical elements.

The main difference between the Wii-console and the proposed devices and methods is that in our case one operates manually with the mechanic elements (real objects), but not with the virtual images. And after that the information about these elements (objects), but not the information about the human body movements, is transferred in a PC and is processed in this PC.

The a.m. working elements can also contain indicators, which indicators are connected with a PC, and which indicators provide the information (data)-transfer (transmission) from this PC to these elements. In this case the a.m. notes or instructions in any form arisen not (or not only) in a PC-display&sound output, but also directly in the indicators or other signalling devices, which are located on (in) the a.m. mechanical elements. In this case a PC processes the a.m. data concerning the relative positions and orientations of the a.m. working elements and transfers the commands to indicators or other signalling devices, which indicators (signalling devices) are located on (in) the a.m. working elements.

Additionally, the different variants of further movements of the a.m. working elements in the virtual form, the correspondent analysis, instructions, notes, considerations, generalizations, interesting or amusing related historical information and cases from practice, videofiles or any other related additional blocks of current related information in the graphical, textual, sound or any other form can be given on the display-, or sound-, or another PC-output. These a.m. “additional blocks of current related information” can be used in all embodiments of the presented invention.

Under the term “PC” one understands in this description all possible kinds of personal computers (a.o. stationary computers, laptops, I-pads, I-pods, mobile telephones, etc.) as well as the non-personal computers for a non-personal usage as well as any electronic devices, which execute the computer functions, among others electronic chips. In the last case the electronic chip (or electronic chips) can, a.o., be located inside the composition of the a.m. working elements (for example, inside the Rubik's cube,) or inside of one (or several, or all) of the working elements.

In one embodiment example the brain-teaser contains a Rubik's cube, PC, PC-display, means for recognising of the mutual arrangements, relative to each other, of the separate moveable mechanical elements of the Rubik's cube, means for transmission (by wire or wireless) of the data about the a.m. relative positions of the elements to the PC, software a) for processing of these data and b) for presenting of the virtual images (a.o. moving virtual images) and current notes or instructions on the PC-display, as well, in a particular case c) for presenting of the sound signals, current notes or instructions on the PC-sound output. Each surface of the Rubik's cube surface squares, both in real cube and in it's virtual image on a display, can be marked, additionally to the colour differences, by separate ciffers or other visual markings. It will help to an user to recognise the mutual correspondence of the elements of real cube and their virtual images on a display.

User manually moves the parts (mechanical working elements) of the Rubik's cube, see on a display a virtual image of the current state of it's surfaces, and get an instruction how to move elements. This instruction can be given a.o. in the form of movement, relative to each other, of the virtual images of the working elements on a PC display. Or with the help of arrows. Or both. These arrows can be placed on display near the correspondent virtual images of the working elements to show the directions they have to be moved to.

Simultaneously the presenting of the a.m. “additional blocks of current related information” can be used in the each step of operations with the Rubik's cube and it's a.m. working elements.

The information about the mutual arrangements, relative to each other, of the separate moveable mechanical elements of the Rubik's cube can be got automatically, as it was described above. In some particular cases (embodiments), enstead, it can be got also manually by a not-automatical identification&location-means for recognising and identification of both the a.m. working elements and also the mutual arrangement of these elements relative to each other (s. detailed description for these group of embodiments below).

In one embodiment example the brain-teaser containing a Rubik's cube, the processed information from the PC is transferred not (or not only) to a display, but also to the indicators, located on the working elements. This way the user get the instructions for further operations from these indicators, or from these indicators together with the information from display.

In one other embodiment example the brain-teaser containing a Rubik's cube, the processing of data takes place in a chip, which one is located inside the Rubik's cube device.

Other embodiments, containing Lego-meccano, any kind of a meccano (or of a kit), puzzle, collection of bricks, or other combinations of the a.m. mechanical working elements), are executed analogously.

In one group of possible embodiments the device can also contain the electrical or (and) electronical elements, among others:

1) the device is an electric diagram or a meccano of electrical details (as for example resistors, capacitors, inductance coils, etc.), which details, after their composing, are building (forming) an electric circuit, or

2) this device is a meccano (kit) for building (forming) of a construction, which meccano (kit) contains both mechanical and electrical or electronical elements (constituents) for this building (forming).

In one of possible embodiments the proposed device can be used not only for children, but also for adults a) for educational aims and b) for the assembling of different complicated constructions in wide spectrum, from pieces of furniture to the home devices. For the assembling of the constructions presently the printed on the paper instructions or video instructions are used. Nevertheless the problem of an easy and quick assembling of any, also complicated construction can be used by the means, detailed described above and below in the claims. In this case instead of the a.m. meccano one used the real construction or device to be assembled, where the supplied separate elements of this construction play the role of the a.m. working elements of the a.m. meccano.

In one group of possible embodiments the a.m. mechanical working elements of a mechanical brain-teaser or of a mechanical game can contain also the not-automatical identification&location-means for recognising and identification of both the a.m. working elements and also the mutual arrangement of these elements relative to each other. In this case the working elements contain a graphical marking (a.o. dash codes, point codes, or others), or a magnetic marking, or any other kind of marking as an ID-coding, where this a.m. marking is put (applied) directly on the external surfaces of these a.m. working elements, or this a.m. marking is put (applied) on a corresponding code-carrier (a.o. on sticking-labels, etiquettes, or others), and these a.m. code-carriers are sticked (or fixed any other way) on the a.m. external surfaces of these a.m. working elements. The device contains correspondently a) the means for reading of these codes, a.o. the means for machine-reading of graphical codes, or the means for reading (taking off) of magnetic codes, or others; and b) the means for recognising of the mutual arrangements of these codes relative to each other on the surface. Besides, this device contains also the means for transmission of the a.m. read information (data) from the a.m. means-for-reading to a PC. In this case a user reads the positions and orientations of working elements manually by placing of the reading means (reading device) near the correspondent surfaces with markings of the a.m. working elements. Then these data are sent to PC, and the further steps are executed analogously to the described above embodiments.

In one separate group of possible embodiments one can present also the examples of table-games, which games contain the mechanically moveable elements. A part of mechanical elements is driven by an electric-mechanical converter (or converters), which converter (converters) generates the mechanical movements of these elements, where the converter is (converters are) controlled by the electric signals, which signals come from a PC. The a.m. games can be, in particular, the two- or more sides partner games (among others table hockey, table football, chess, or others), where the a.m. part of mechanical elements is supposed to be driven, according to a game rules or logic, not by user, but by the opposite side. With another words a part of the elements exists, which movement is supposed to be executed by one of the opposite in respect to the user sides in a partner game (among others by black- or white-side in chess, by one of the team-side in a table hockey or football, or others). This a.m. part of mechanical elements can be driven by the a.m. electric-mechanical converter, which one is controlled by the signals from the a.m. PC.

The data-processing can take place both inside a PC of a user (off-line), and, completely or partially, outside of this PC (on-line). In the second case the user connects his PC firstly with a correspondent website, wherein (i.e. in the computers or electronic devices, which are supporting this a.m. website) this a.m. data-processing is, completely or partially, executed.

What is claimed is:

1) A mechanical brain-teaser or a mechanical game, which one contains a.o. (among others) a collection or a composition of mechanical elements (in the future they are named as “working elements”), which elements are made such way, that one or more definite placings (or orientations, or both) in the space of these elements relative to each other provide the assembling of these elements together some definite way, which definite variant (or variants) of the assembling is (are) considered as a true one (a.o. Rubik's cube, Lego-meccano, any kind of a meccano (or of a kit), puzzle, collection of bricks, or others),
where the above-mentioned working elements are made with the possibility to recognise and identify both these working elements themselves and the relative positioning (or orientation or both) of these elements relative to each other by means of a PC with its periphery-devices, or by any other electronic device; or also a relative position of at least two of these working elements is recognisable by a PC (or by any other electronic device), where under the term “PC” one understands all possible kinds of computers (a.o. stationary personal computers, laptops, I-pads, I-pods, mobilephones, etc.) as well as big non-personal computers for non-personal usage.

2. Device according to claim 1,
where a mechanical brain-teaser or a mechanical game on claim 1 contains means (further named as “ID&Location-means”) for an automatical recognising and identification of both the working elements on claim 1 and also the space-placing of these elements relative to each other; as well as the a.m. device on claim 1 contains means for the transmission of information (data) about the relative space-placing of these working elements relative to each other to a PC, where the electronic processing of this information (data) concerning the identification, location and, in some cases also orientation of the a.m. working elements takes place either in the PC or in the a.m. ID&Location-means or both.

3. Device according to claim 1,
where a mechanical brain-teaser or a mechanical game on claim 1 contains not-automatical ID&Location-means for recognising and identification of both the working elements on claim 1 and also the space-placing of these elements relative to each other, where the working elements on claim 1 contain a graphical marking (a.o. dash codes, point codes, or others), or a magnetic marking, or any other kind of marking as an ID-coding, where this a.m. marking is put (applied) directly on the external surfaces of these a.m. working elements, or this a.m. marking is put (applied) on a corresponding code-carrier (a.o. on sticking-labels, etiquettes, or others), and these a.m. code-carriers are sticked (or fixed any other way) on the a.m. external surfaces of these a.m. working elements, where this device contains the means for reading of these codes, a.o. the means for machine-reading of graphical codes, or the means for reading (taking off) of magnetic codes, or others, and where this device contains means for transmission of the a.m. read information (data) from the a.m. means-for-reading to a PC.

4. Device according to claim 2,
where a mechanical brain-teaser or a mechanical game contains not-automatical ID&Location-means on claim 2, where the working elements contain a graphical marking (a.o. dash codes, point codes, or others), or a magnetic marking, or any other kind of marking as an ID-coding, where this a.m. marking is put (applied) directly on the external surfaces of these a.m. working elements, or this a.m. marking is put (applied) on a corresponding code-carrier (a.o. on sticking-labels, etiquettes, or others), and these a.m. code-carriers are sticked (or fixed any other way) on the a.m. external surfaces of these a.m. working elements, where this device contains the means for reading of these codes, a.o. the means for machine-reading of graphical codes, or the means for reading (taking off) of magnetic codes, or others, and where this device contains means for transmission of the a.m. read information (data) from the a.m. means-for-reading to a PC.

5. Device according to claim 1,
where the working elements contain the indicators, which indicators are connected with a PC with the possibility to get information from the PC and react on this information with an optical, vibrational, sound, or any other kind of signal, where the device contains means for the information (data)-transmission from this PC to these indicators, which indicators are fixed on- or inside these working elements.

6. Device according to claim 2,
where the working elements contain the indicators, which indicators are connected with a PC with the possibility to get information from the PC and react on this information with an optical, vibrational, sound, or any other kind of signal, where the device contains means for the information (data)-transmission from this PC to these indicators, which indicators are fixed on- or inside these working elements.

7. Device according to claim 3,
where the working elements contain the indicators, which indicators are connected with a PC with the possibility to get information from the PC and react on this information with an optical, vibrational, sound, or any other kind of signal, where the device contains means for the information (data)-transmission from this PC to these indicators, which indicators are fixed on- or inside these working elements.

8. Device according to claim 4,
where the working elements contain the indicators, which indicators are connected with a PC with the possibility to get information from the PC and react on this information with an optical, vibrational, sound, or any other kind of signal, where the device contains means for the information (data)-transmission from this PC to these indicators, which indicators are fixed on- or inside these working elements.

9. Device according to claim 1,
where a part of mechanical elements is driven by an electric-mechanical converter (or converters), which one generates the mechanical movements of these elements, where the converter is (converters are) controlled by the electric signals, which signals come from a PC.

10. Device according to claim 2,
where a part of mechanical elements is driven by an electric-mechanical converter (or converters), which one generates the mechanical movements of these elements, where the converter is (converters are) controlled by the electric signals, which signals come from a PC.

11. Device according to claim 3,
where a part of mechanical elements is driven by an electric-mechanical converter (or converters), which one generates the mechanical movements of these elements, where the converter is (converters are) controlled by the electric signals, which signals come from a PC.

12. Device according to claim 4,
where a part of mechanical elements is driven by an electric-mechanical converter (or converters), which one generates the mechanical movements of these elements, where the converter is (converters are) controlled by the electric signals, which signals come from a PC.

13. Game, in particular a table-game (Brettspiel), which one contains the mechanical elements,
where a part of mechanical elements is driven by an electric-mechanical converter (or converters), which one generates the mechanical movements of these elements, where the converter is (converters are) controlled by the electric signals, which signals come from a PC; where in particular the a.m. game is a two- or more sides partner game (among others table hockey, table football, chess, or others), where the a.m. part of mechanical elements to be driven by the a.m. electric-mechanical converter, is a part of elements, which movement is supposed to be executed by one of the sides in a partner game (among others by black- or white- side in chess, by one of the team-side in a table hockey or football, or others).

14. Device according to claims 1,
where the device contains the electrical or electronical elements, among others a) this device is an electric diagram, or an electronic diagram with a meccano (kit) of electrical or electronical details (as for example resistors, capacitors, inductance coils, etc.), which details are building (forming) an electric or an electronic circuit, or b) this device is a meccano (kit) for building (forming) of a construction, which meccano (kit) contains both mechanical and electrical (or electronical or both) elements or constituents for building.

15. Device according to claims 2,
where the device contains the electrical or electronical elements, among others a) this device is an electric circuit, or an electronic circuit, or a meccano (kit) of electrical or electronical details (as for example Resistors, capacitors, inductance coils, etc.), which details are building (forming) an electric or an electronic circuit, or b) this device is a meccano (kit) for building (forming) of a construction, which meccano (kit) contains both mechanical and electrical (or electronical or both) elements or constituents for building.

16. Device according to claims 4,
where the device contains the electrical or electronical elements, among others a) this device is an electric circuit, or an electronic circuit, or a meccano (kit) of electrical or electronical details (as for example Resistors, capacitors, inductance coils, etc.), which details are building (forming) an electric or an electronic circuit, or b) this device is a meccano (kit) for building (forming) of a construction, which meccano (kit) contains both mechanical and electrical (or electronical or both) elements or constituents for building.

17. Device according to claims 6,
where the device contains the electrical or electronical elements, among others a) this device is an electric circuit, or an electronic circuit, or a meccano (kit) of electrical or electronical details (as for example Resistors, capacitors, inductance coils, etc.), which details are building (forming) an electric or an electronic circuit, or b) this device is a meccano (kit) for building (forming) of a construction, which meccano (kit) contains both mechanical and electrical (or electronical or both) elements or constituents for building.

18. Device according to claims 8,
where the device contains the electrical or electronical elements, among others a) this device is an electric circuit, or an electronic circuit, or a meccano (kit) of electrical or electronical details (as for example Resistors, capacitors, inductance coils, etc.), which details are building (forming) an electric or an electronic circuit, or b) this device is a meccano (kit) for building (forming) of a construction, which meccano (kit) contains both mechanical and electrical (or electronical or both) elements or constituents for building.

19. Method of execution of a game with mechanical elements (materials, objects, toys, or others, in particular on claim 1), where the recognising and identification both of these elements themselves and also of the relative arrangement of these elements one near another is executed by means of a PC and its periphery-devices,
where the recognising and identification both of these elements themselves and also of the mutual arrangements of these elements relative to each other, as well as all further data processing is executed off-line, inside the a.m. PC and its periphery-devices by means of the contained in this PC and its periphery-devices software and hardware.

20. Method on claim 19,
where the data processing is executed completely or partially outside the a.m. PC and its periphery-devices, where one firstly connects this PC with a corresponding website, and then there (i.e. in the computers or electronic devices, which support this a.m. website) the data processing will be executed, completely or partially, and therewith the all method is executed on-line (in an on-line modus).
